(19) United States
(12) Patent Application Publication
(10) Pub. No.: US 2004/0201603 A1
(43) Pub. Date: Oct. 14, 2004

(54) Method of creating skin images for mobile phones

(76) Inventor: Dan Kalish, (US)

Correspondence Address: KATTEN MUCHIN ZAVIS ROSENMAN, 575 MADISON AVENUE, NEW YORK, NY, 10022-2585, US

(21) Appl. No.: 10/777,534

(22) Filed: Feb. 11, 2004

Related U.S. Application Data
(60) Provisional application No. 60/447,296, filed on Feb. 14, 2003.

(51) Int. Cl. G09G 5/00

(52) U.S. Cl. 345/700; 709/217; 715/513

(57) ABSTRACT

A method for providing skin images for cellular micro browsers is disclosed. The invention allows users of cellular phones to personalize the appearance of their browser according to preference. Due to the micro browser's memory limitations the preferred embodiment of the present invention integrates the chosen skin image with the content page on the service provider's servers. The skin image preference may be defined so that the image is integrated statically and appears in the same manner on all pages, or dynamically adjusted to the content of the page. To fit the format of the micro browser the chosen image must be divided into segments and each segment is them integrated with the page components according to their order of appearance.

### BACKGROUND OF THE INVENTION

The present invention relates to wireless networks browsing practices. More specifically, the invention relates to utilities for creating skin images for display on mobile phone screens.

On the Internet, a skin is a graphic or audio file used to change the appearance of the user interface of a program such as the computer's desktop and browser. When using a skin, the appearance of the user interface changes, but not the functions available with the program. Skins usually give programs a look that corresponds with a specific theme such as the colors, signs and images of a favorite sports team or of a movie.

Presently, in the field of cellular phones the only equivalents to skins are the phone covers or the face plates. Changing the phone cover allows owners of cellular phones that are equipped for it to change the appearance of the phone by replacing the outer physical coating. The Xpress-On covers, for example, that snap to the front of the Nokia cell phone come in various colors and graphic designs. The covers alter the physical appearance of the device but not the appearance of its graphical user interface.

Connecting to the internet environment through the cellular phone devices is achieved by using micro browsers. These micro browsers provide a hyperlink interface to the internet but they have limited capacities and lack various standard capabilities which are included in desktop computers' internet browsers. One of the capacities that micro browsers lack is the ability to personalize the appearance of the browser's user interface. Adding skins to these browsers is problematic for two main reasons. First, since the micro browsers of mobile phones have a limited memory the skins cannot utilize its memory. Further more, prior art skin utilities operate according to principles that cannot be utilized in devices with small displays such as the mobile phones. The skins are limited to a specific layout and regard their images in their entirety. Whilst for large displays of personal computer, this layout limitation has no significance; mobile phones' small screen display makes it crucial to overcome this layout limitation.

It is thus the prime object of the invention to provide a method and system for generating dynamic skin image for constrained display devices such as mobile phone screens.

### SUMMARY OF THE INVENTION

The present invention discloses a method for creating skin images for hypertext language based pages (“content pages”) to be displayed on mobile phone device screens. The skin image is added to the content page by merging its segmented sections to the page's elements according to rules. The merging is processed in real-time before the content page is displayed on the phone's screen. The rules defining the display of the skin image on screen may be dynamic, enabling real-time adaptation of skin section merging in accordance with the content page graphic layout and page elements functional type. The merging rules may be defined by the user or by the service provider. Skin images are chosen from the images database which is situated on the service providers' servers. Users may also store images there and turn them into skin images. The selected skin image and its preferences may be programmed to change according the schedule and location.

### BRIEF DESCRIPTION OF THE DRAWINGS

These and further features and advantages of the invention will become more clearly understood in light of the ensuing description of a few preferred embodiments thereof, given by way of example only, with reference to the accompanying drawings, wherein

FIG. 1 is a general diagrammatic representation of the environment in which the present invention is implemented;

FIG. 2 is a flow-chart of the process of providing mobile users with dynamic skin image according the present invention;

FIG. 2.1 is a flow-chart of providing mobile phone users with static skin image according the present invention;

FIG. 3 is an example of a skin image;

FIG. 4 is an example of the segmentation of a specific mobile page structure;

FIG. 5 is an example of a sliced skin image;

FIG. 6 is an example of applying a skin image to a specific mobile page structure.

### DETAILED DESCRIPTION OF THE PREFERRED EMBODIMENTS

The present invention provides a means for cellular phone users to alter the appearance of the graphic user interface of their mobile device. The invention is similar in many respects to the installation of a skin for a program on the desktop computer. Once the user loads the new skin on the mobile device, the appearance of the graphic user interface is replaced, but the functionality of the phone remains unchanged.

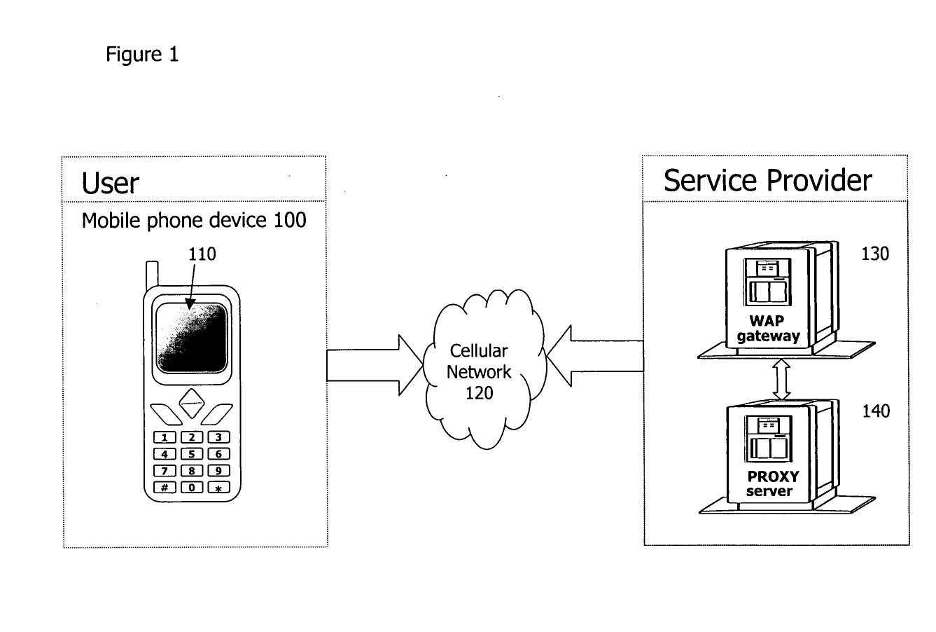

FIG. 1 illustrates one possible network configuration, in which the present invention can be implemented. In this illustration a user mobile device 100 is connected through a cellular network 120 to the servers of a service provider. The service provider's environment may include a gateway 130 and/or a proxy 140 server. The graphic user interface display 110, to which the present invention refers, is a part of the user mobile device 100.

Let us assume that a user has placed a request for a hypertext based data file (hereinafter called the “content page”). The common standard for such pages in cellular networks is the WML page. According to prior art routines, whenever a user places a request for a content page through a wireless network, the gateway or proxy server retrieves the page from the cache memory or from the content server source. The page is then forwarded back to the user mobile phone device in the same format in which it was received.

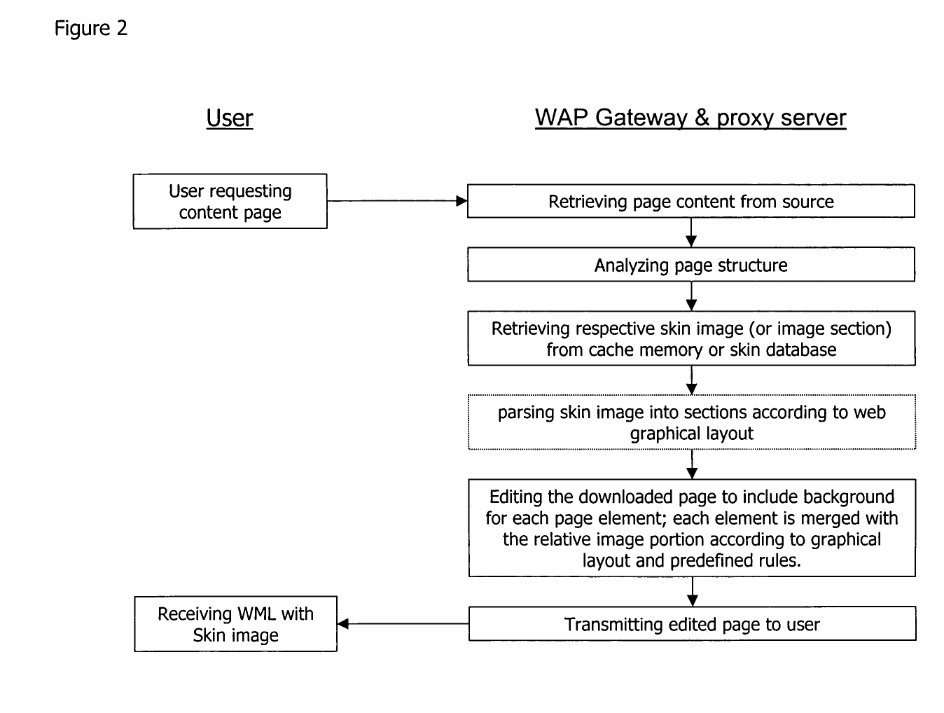

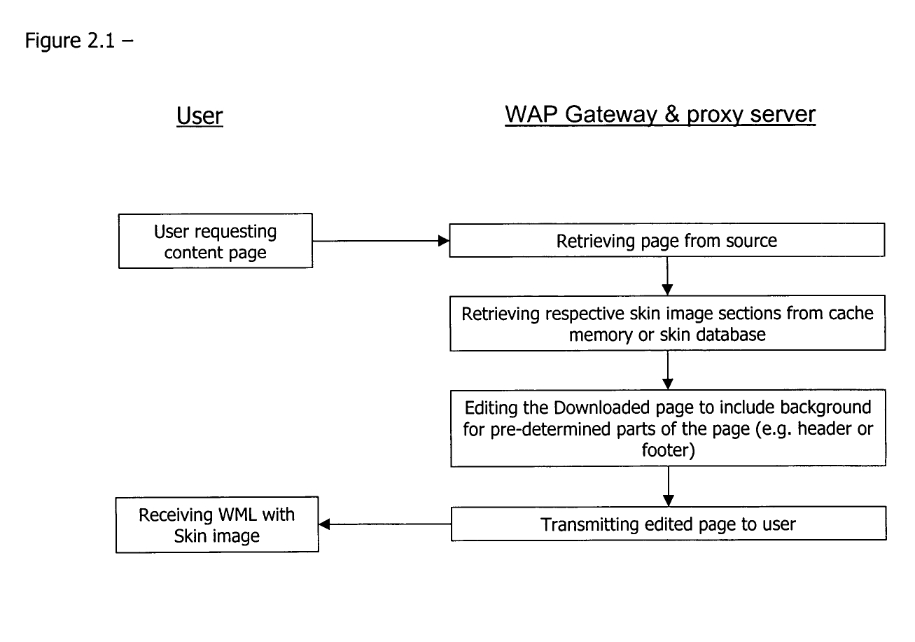

FIG. 2. illustrates a block diagram of this process, in accordance to the present invention, of enabling mobile phone browsers to retrieve skin images. As described in the block diagram, it is herein proposed that before transmitting the content page through the wireless network, the page is modified to include a background image. This modification process is not supported by the micro browser, thus according to the present invention, the image is sliced into sections that correspond with the page's elements, and each section is merged with the appropriate element. Hence, when the content page arrives at the user device, the user sees the original content page with the skin image background.

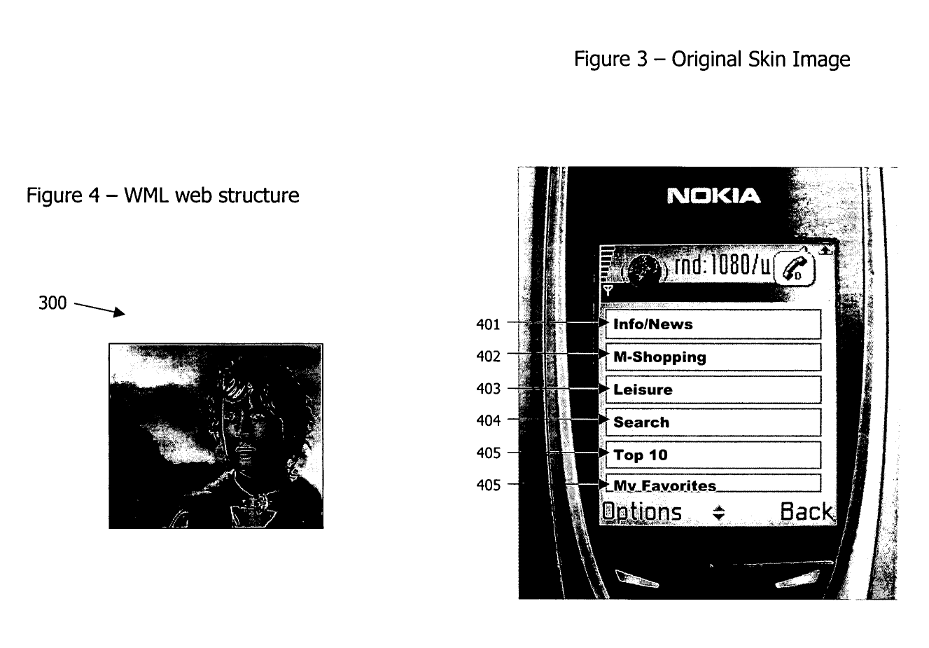

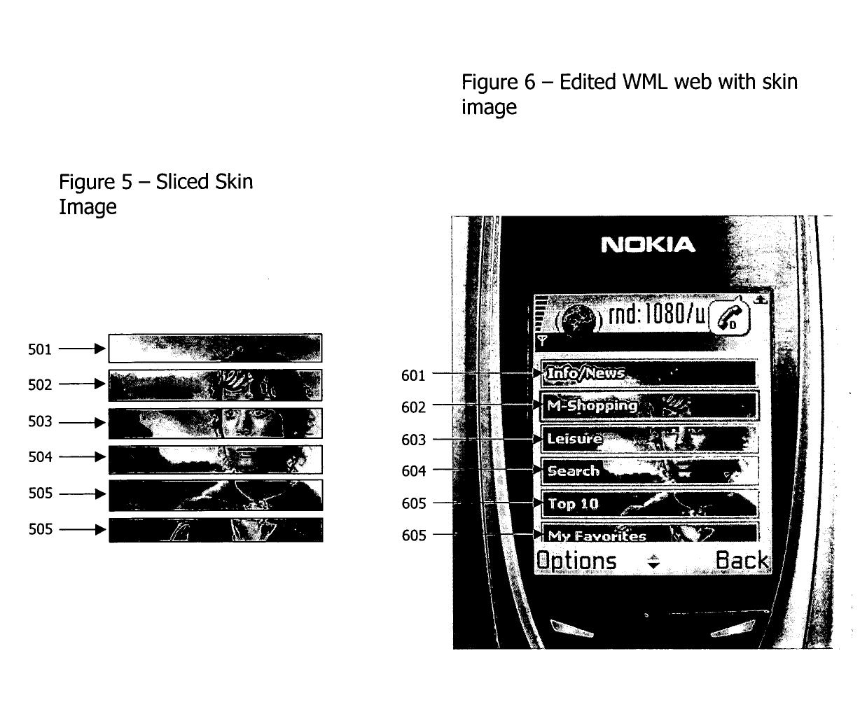

FIGS. 3 to 6 provide a graphic illustration for the stages for this process. First, the user selects a skin image 300. Second, the system identifies the micro browser's divisions into elements, in this example the page is divided into six hyperlinks 401-406. Finely, the skin image is divided accordingly into six segments 501-506, and each section is then integrated with the appropriate hyperlink to create a skinned hyperlink 601-606.

The merging process of the image section and page elements is designed according to image sections sequence; hence the image segments displayed on the user screen appear in the correct order.

The users can select their favorite skin image or choose to replace the image through the preferences settings in skin image service, provided by the cellular network provider. The image may be selected from an image database, or alternatively, users can add any image from an external source. For example users may take a photo by means of their mobile phone, send a MMS of their picture to the skin image service database, and select their photo as the preferred skin image.

The selected images are preferably recorded at the local cache of the proxy or at a remote database server. At the beginning of each surfing session, which includes user requests for a new content page, the proxy server checks the skin image preference setting and retrieves the respective image from the cache memory or from the designated database server.

Before editing the page and inserting the skin image, the proxy server analyses the page structure and graphic layout. The skin image may be retrieved in its original form and then the segmentation of the image is done by the proxy server (in which case the segmentation is done according to the content page graphical layout considerations) or retrieved in a sliced format.

The proxy server holds predefined rules for merging the skin image with the content page; the rules determine the merging process according to the page graphical layout and/or the function of each page element (e.g. Hyperlink). For example, the rules may define to incorporate the skin image sections only to the page header or footer. Another rule may define merging segments of the skin image only with the hyperlink elements, leaving the text elements with no background skin image.

The merging rules are dynamic, adapting the skin image appearance to browsing and display capabilities (constrains) of the specific mobile phone and the graphical appearance (layout) of the displayed content page. The rules may be further defined according to users' preferences or by the content providers' restrictions. For example the users or the content providers may define that the skin image background skin image may not merge with text elements of the content page.

The dynamic merging rules have an additional advantage for personalized content pages. The personal content pages' structure and graphic layout are dynamic and change according to users' preferences. For example, the order of displayed hyperlinks may be changed according to the historic behavior of the users. Thus, the hyperlinks order of appearance on the users' screen may change and be different from the original order. If the skin image sections are merged with the original content page the skin image sections will appear in disorder on the user screen.

FIG. 2.1 illustrates a process of creating skin image according to static rules. This process is a simplified procedure of skin image creation, in which the skin image layout is standard for all content pages. For example the content pages may always display the top and bottom of the skin image at the page footer and header.

According to alternative embodiment of the present invention, the process of creating the skin image may be implemented at the micro browser of the mobile device. Such implementation can be utilized by micro browsers which are incorporated in a new generation mobile phone devices. The process of merging the segments of the skin images with content pages by the micro browser is similar to the procedure described above. The preference setting and skin images can then be stored at the mobile phone micro browser or imported form the proxy server according to the mobile phone memory constrains.

The skin creation process is a fully transparent solution. It is easy to deploy and does not impose any requirements on existing systems of content providers or on the micro browser. Whatever infrastructure is used by the content provider, the skin dynamic rules enable the merging of the skin image section with any given content. Furthermore, different skins types may be made available to different devices according to their capabilities. The skin image creation capabilities as described above can be applied to any content or service. The skin is present during the entire surfing session, both in internal and external services. The users can also change their personalized skin image in mid-session.

While the operation of changing the skin images may be initiated manually, the skin preference can also be programmed to change automatically according the different rules. The skin image may be programmed to change once at a specific time, or regularly as certain hours. Changing regularly may enable users to have a morning skin which is different than the evening one, or having a different skin on week day than on the weekend. The skin image preference may also be programmed to change the skin image according to the mobile device's geographic location. Changing the skin image may be set by the mobile device user, or determined by the service provider according the users' profiles.

Finally, it should be appreciated that the above described embodiments are aimed at a cellular communication environment. However, the invention in its broad aspect is equally applicable to computerized network communication in general, such as satellite, blue-tooth, and others.

While the above description contains many specificities, these should not be construed as limitations on the scope of the invention, but rather as exemplifications of the preferred embodiments. Those skilled in the art will envision other possible variations that are within its scope. Accordingly, the scope of the invention should be determined not by the embodiments illustrated, but by the appended claims and their legal equivalents.

What is claimed is:

1. A method for creating skin image for hypertext language based pages (“content pages”) to be displayed on mobile phone device screens, by merging segmented skin image sections to content page elements according to rules wherein the merging is processed in real-time before displaying the page-content.

2. The method of claim 1 wherein the rules are dynamic enabling real-time adaptation of skin section merging in accordance with the content page graphic layout and page elements functional type.

3. The method of claim 1 wherein the rules are static applying the same rules to all content pages.

4. The method of claim 1 wherein the skin image creation is processed at designated proxy server.

5. The method of claim 1 wherein the skin image creation is processed at mobile phone micro browser.

6. The method of claim 1 wherein the dynamic merging rules are defined by the user.

7. The method of claim 1 wherein the dynamic merging rules are defined by the service providers.

8. The method of claim 2 wherein the skin images are retrieved from cache memory of the designated remote server according to user preferences.

9. The method of claim 3 wherein the skin images are retrieved from cache memory of the micro browser according to user preferences.

10. The method of claim 3 wherein the skin images are retrieved from cache memory of a designated remote server according to user preferences.

11. The method of claim 1 wherein the skin images arrive in their original form, further comprising the step of parsing the skin images according to the content page graphical layout.

12. The method of claim 1 wherein the skin image content can changed according to predefined rules;

13. The method of claim 10 wherein the rules relate to geographical location of the mobile phone device.

14. The method of claim 10 wherein the rules relate to time schedule.

15. The method of claim 10 wherein the rules relate to content pages type;

16. The method of claim 10 wherein the rules are defined by the mobile phone user by updating his profile.

17. The method of claim 10 wherein the rules are defined by content provider.

18. A method for creating skin images for hyper text language based pages (“content page”) to be displayed on mobile phone device screens, said method comprising the steps of:
A. Retrieving content page in response to a request received by a mobile phone;
B. Retrieving skin image sections according to user preference settings;
C. Merging skin image sections with content page elements according to dynamic rules based on content page graphical layout and/or page elements functional type;
